(19) United States
(12) Patent Application Publication
(10) Pub. No.: US 2016/0150547 A1
(43) Pub. Date: May 26, 2016

(54) Interference Mitigation in Strong Imbalance Zone

(71) Applicant: Nokia Solutions and Networks Oy, Espoo (FI)

(72) Inventors: Amaanat ALI, Espoo (FI); Marcin RYBAKOWSKI, Rawicz (PL); Karri Markus RANTA-AHO, Espoo (FI); Alexander SAYENKO, Espoo (FI); Hans Thomas HOEHNE, Helsinki (FI)

(21) Appl. No.: 14/897,865

(22) PCT Filed: Jun. 11, 2013
(86) PCT No.: PCT/EP2013/061981

§ 371 Date: Dec. 11, 2015

(51) Int. Cl. H04W 72/08; H04W 72/04; H04L 5/00; H04J 11/00

(52) U.S. Cl. CPC H04W 72/082; H04J 11/0056; H04W 72/0413; H04L 5/0032

(57) ABSTRACT

It is provided a method, including monitoring an interference from at least one terminal device not served by an apparatus performing the method; checking if the interference exceeds a threshold; informing, if the interference exceeds the threshold, a serving receiving device considered to serve the at least one terminal device that the interference exceeds the threshold.

### FIELD OF THE INVENTION

The present invention relates to an apparatus, a method, a system, and a computer program product related to mobile communication networks, in particular to HSPA evolution. More particularly, the present invention relates to an apparatus, a method, a system, and a computer program product for heterogeneous networks.

### BACKGROUND OF THE INVENTION

### Abbreviations

3GPP 3^{rd} Generation Partnership Project
AS Access Stratum
BTS Base Transceiver Station
CIO Cell Individual Offset
CPICH Common Pilot Channel
CmCH-PI Common Transport Channel Priority Indicator
DL Downlink
eNB Evolved Node B
E-AGCH Enhanced Uplink Absolute Grant CHannel
E-RGCH Enhanced Uplink Relative Grant CHannel
HetNet Heterogeneous Network
HSDPA High Speed Downlink Packet Access
LPN Low Power Node
LTE™ Long Term Evolution
LTE-A™ Long Term Evolution- Advanced
MAC Medium Access Control
MF Multiflow
NBAP NodeB Application Protocol
Rel Release
RNC Radio Network Controller
RoT Rise over Thermal
RRC Radio Resource Control
RRM Radio Resource Management
RTWP Received Total Wideband Power
RX Receive
SINR Signal to Interference and Noise Ratio
SIZ Strong Imbalance Zone
SPI Scheduling Priority Indicator
TF Transport Format
TS Technical Specification
TX Transmit
UE User Equipment
UL Uplink
UMTS Universal Mobile Telecommunication System
USP User Service Profile
UTRA UMTS Radio Access
UTRAN UMTS Radio Access Network
WCDMA Wideband Code Division Multiplex Access
WiFi™ Wireless Fidelity

The application is related to mitigating the interference caused by UEs to small cell uplink users in particular when such UEs are in a Strong Imbalance Zone of a HetNet (See e.g. the following 3GPP contributions of Nokia Siemens networks: R1-131599: UL/DL mismatch effect on SHO/MF operation and R1-131600: Considerations on Strong Imbalance Zone). This type of interference is called inter-cell interference and cannot be mitigated except by specialized methods.

Small cells have, compared to macro cells, a much lower DL transmission power, however the UL power of a UE served by a macro cell is maintained at the same level to be received by the serving macro cell. When the UE is connected to different transmit stations with different P-CPICH powers, it will be in imbalance as far as the uplink is concerned. The problem has been described in many HetNet 3GPP contributions and as such is well known.

FIG. 1 shows an exemplary HetNet deployment with a macro BTS constituting a macro cell and a LPN BTS constituting a small cell. UEs in region A are served by the macro BTS (macro cell) and have low or even very low UL interference to LPN. UEs in region C are served by the LPN (low power node or small cell) and adapt their uplink according to the grants received from LPN. UEs that are in the region B (closely around region C between region C and the macro BTS) are typically in a SIZ (Strong Imbalance Zone), where they are served by the macro cell but cause strong UL interference to LPN.

It should be understood that while above terminology is common for describing UMTS networks, the described methods also apply to LTE and LTE-A networks, where the BTS is usually referred to as a eNodeB. For LTE and LTE-A systems, the functionality of the RNC is incorporated in one or more eNodeBs or a central coordinating network element.

FIG. 2 sketches the signal strengths between macro BTS and LPN BTS exemplarily. In FIG. 2, the path between macro and LPN BTS (e.g. pico BTS), is divided into several zones. In FIG. 2, it is assumed that the received UL/DL signal strength decreases linearly with the distance from the respective base station. However, linear decrease is only exemplary and not limiting. In FIG. 2, DL coverage (thick dashed lines) of the macro BTS extends slightly larger than uplink coverage (thin dashed lines), but this is exemplary only, too. DL coverage of the small cell is much less than its UL coverage. No coverage means that the respective received power or S/(N+I) (ratio of signal to noise plus interference) is below a certain threshold value, as defined e.g. in 3GPP TS 25.133.

The arrows at the bottom indicate zones at the boundary area between macro BTS and small BTS:

In zone A (UL SHO zone), downlink of the macro BTS is stronger than downlink of LPN BTS. The UE is served by macro BTS. On the left side of zone A, UL to macro BTS is stronger than UL to LPN BTS, whereas this is different on the right side. The point with equal uplink SINR is marked by “same UL SINR”. This zone is also called the SIZ because the UE acts as an interferer to the LPN uplink users. A notable characteristic of the SIZ is also that the LPN cannot reach the interfering UE in the DL and hence cannot control the UL Tx power of the interfering UE. Zone A of FIG. 2 corresponds to region B of FIG. 1.

In zone B, the SINR of the UL to macro BTS becomes very small (below a threshold), but DL of the macro BTS is still higher than that of the LPN BTS. In this zone, conventional (DL) SHO may take place. This zone is shown extended compared to the conventional DL pilot boundary of the LPN because of application of an, optional, CIO.

In zone C, uplink and downlink of the LPN are stronger than those of the macro BTS. The UE is served by the LPN BTS.

When the UE is in zone A of FIG. 2 (or between the Same UL SINR dotted line and to its right and ending at the DL Boundary LPN reference marker), it will be dominantly interfering to the users being served by the LPN uplink. The problem stems from the fact that these interfering users are served (also scheduled in the uplink) by the Macro BTS (i.e. they receive their Serving Grants from the Macro BTS) and as such the Macro BTS will only consider its local noise rise budget when scheduling such UEs. These UEs create varying levels of interference to the LPN uplink users. In severe cases, these UEs will block the LPN uplink completely and then the self user uplink capacity of the LPNs (facing such interference) will be critically reduced. The interference level from those macro UEs is increasing proportionally to distance of small cell from macro cell.

The LPN does not have a way of controlling these users. This is simply because the LPN is not in the active set of these UEs. Furthermore, users in the SIZ cannot receive the downlink of the LPNs to which these users interfere. Hence the job of controlling the interference from such users needs a totally new approach not covered by legacy solutions (e.g. addition of such UEs to the active set).

In the context of this application, these UEs are sometimes named interfering UEs and the

LPN is sometimes named victim LPN. These namings are based on the explanation in the previous paragraphs.

Prior art 1: PCT/EP2013/057220: UL serving link's role change during HSDPA Multiflow operation in WCDMA Heterogeneous network

It discusses about scheduling role transfer to the weaker node (e.g. Macro BTS) assisted by the stronger node (e.g. LPN). This application considers only UEs in the SHO Zone.

Prior art 1 defines the terminology of a strong and a weak cell. A strong cell is defined as a base station that dominates the power control in the uplink (because of lower path loss). A weak cell is defined as a base station that has very poor grip on the power control in the uplink (because of much higher path loss). These definitions implicitly assume the cells are in imbalance and are part of the active set of the UE.

In the present application, there is a different relationship. The relationship is of interfering UEs and victim LPNs. Correspondingly the cells are serving cell (scheduling the interfering UE) and victim cell (one of the LPNs which see the transmission of this interfering UE) respectively.

In this prior art, the UE has macro and LPN both in its active set. In the imbalance zone, the macro sends the scheduling commands to the UE (based on its allowable noise rise for this UE) but the LPN keeps cancelling the grant allocation of the macro based on its allowable noise rise budget.

This prior art proposes that the LPN provides the UL grants/UL Tx power allocation to the UE. Thus, LPN can facilitate a more efficient macro scheduling by communicating the maximum permissible grant value, where this maximum value would account for LPN internal aspects.

Prior art 2: 3GPP R1-131575

Qualcomm has disclosed adding users in the SIZ to an Extended Active Set so as to influence the LPN to power down these users. This is done by asking the UEs to listen to a common E-RGCH channel.

Prior art 3: Inter Cell Interference Cancellation (ICIC).

In ICIC, a set of dominant interferers could be cancelled by advance knowledge of these interferers (for this, the base station receiver needs to know already some parameters relating to the interferer, e.g. UL scrambling code, radio link parameters etc.).

The main issue of this feature is that small interferers cannot be cancelled since they will all total themselves to the victim node as white (rather than coloured noise). In addition, special algorithms are needed to nullify such interferers and such algorithms may become very complex to implement and they take a lot of computing resources and may not have the right balance of cost/benefit.

Prior art 4: PCT/EP2013/057190.: Method for estimating uplink switch triggering point in WCDMA HetNet deployments

In this application, location of UEs in SIZ is discussed.

### SUMMARY OF THE INVENTION

It is an object of the present invention to improve the prior art. In detail, it is an object to reduce UL interference from UEs in SIZ to LPN.

According to a first aspect of the invention, there is provided an apparatus, comprising monitoring means adapted to monitor an interference from at least one terminal device not served by the apparatus; checking means adapted to check if the interference exceeds a threshold; informing means adapted to inform, if the interference exceeds the threshold, a serving receiving device considered to serve the at least one terminal device that the interference exceeds the threshold.

In the apparatus, the informing means may be adapted to inform plural receiving devices including the serving receiving device by broadcasting or multicasting that the interference exceeds the threshold.

The apparatus may further comprise receiver identifying means adapted to identify the serving receiving device serving the at least one terminal device.

The apparatus may further comprise terminal identifying means adapted to identify an identified terminal device of the at least one terminal device causing the interference; wherein the receiver identifying means is adapted to identify the serving receiving device serving the identified terminal device.

In the apparatus, the informing means may be further adapted to inform the serving receiving device about at least one of a target interference and an upper limit of the interference, wherein the at least one of the target interference and the upper limit of the interference is related to the threshold.

According to a second aspect of the invention, there is provided an apparatus, comprising monitoring processor adapted to monitor an interference from at least one terminal device not served by the apparatus; checking processor adapted to check if the interference exceeds a threshold; informing processor adapted to inform, if the interference exceeds the threshold, a serving receiving device considered to serve the at least one terminal device that the interference exceeds the threshold.

In the apparatus, the informing processor may be adapted to inform plural receiving devices including the serving receiving device by broadcasting or multicasting that the interference exceeds the threshold.

The apparatus may further comprise receiver identifying processor adapted to identify the serving receiving device serving the at least one terminal device.

The apparatus may further comprise terminal identifying processor adapted to identify an identified terminal device of the at least one terminal device causing the interference; wherein the receiver identifying processor is adapted to identify the serving receiving device serving the identified terminal device.

In the apparatus, the informing processor may be further adapted to inform the serving receiving device about at least one of a target interference and an upper limit of the interference, wherein the at least one of the target interference and the upper limit of the interference is related to the threshold.

According to a third aspect of the invention, there is provided an apparatus, comprising monitoring means adapted to monitor an interference from at least one terminal device not served by the apparatus; checking means adapted to check if the interference exceeds a threshold; informing means adapted to inform, if the interference exceeds the threshold, a control device controlling the apparatus that the interference exceeds the threshold.

The apparatus may further comprise receiver identifying means adapted to identify a serving receiving device serving the at least one terminal device; wherein the informing means may be further adapted to inform the control device of the serving receiving device.

The apparatus may further comprise terminal identifying means adapted to identify an identified terminal device of the at least one terminal device causing the interference; wherein the informing means may be further adapted to inform the control device on the identified terminal device.

In the apparatus, the informing means may be further adapted to inform the control device about at least one of a target interference and an upper limit of the interference, wherein the at least one of the target interference and the upper limit of the interference is related to the threshold.

According to a fourth aspect of the invention, there is provided an apparatus, comprising monitoring processor adapted to monitor an interference from at least one terminal device not served by the apparatus; checking processor adapted to check if the interference exceeds a threshold; informing processor adapted to inform, if the interference exceeds the threshold, a control device controlling the apparatus that the interference exceeds the threshold.

The apparatus may further comprise receiver identifying processor adapted to identify a serving receiving device serving the at least one terminal device; wherein the informing processor may be further adapted to inform the control device of the serving receiving device.

The apparatus may further comprise terminal identifying processor adapted to identify an identified terminal device of the at least one terminal device causing the interference; wherein the informing processor may be further adapted to inform the control device on the identified terminal device.

In the apparatus, the informing processor may be further adapted to inform the control device about at least one of a target interference and an upper limit of the interference, wherein the at least one of the target interference and the upper limit of the interference is related to the threshold.

According to a fifth aspect of the invention, there is provided an apparatus, comprising monitoring means adapted to monitor if an information is received that an interference at a receiving device not serving a terminal device exceeds a threshold; altering means adapted to alter an uplink grant of the terminal device based on the received information, wherein the uplink grant is related to an uplink from the terminal device to the apparatus.

In the apparatus, the monitoring means may be further adapted to monitor if the information comprises an identification of an identified terminal device; wherein the apparatus may further comprise checking means adapted to check if the identified terminal device is the terminal device; preventing means adapted to prevent the altering means from altering the uplink grant if the identified terminal device is different from the terminal device.

In the apparatus, the altering means may be adapted to alter the uplink grant by modifying a priority of an uplink medium access control flow.

According to a sixth aspect of the invention, there is provided an apparatus, comprising monitoring processor adapted to monitor if an information is received that an interference at a receiving device not serving a terminal device exceeds a threshold; altering processor adapted to alter an uplink grant of the terminal device based on the received information, wherein the uplink grant is related to an uplink from the terminal device to the apparatus.

In the apparatus, the monitoring processor may be further adapted to monitor if the information comprises an identification of an identified terminal device; wherein the apparatus may further comprise checking processor adapted to check if the identified terminal device is the terminal device; preventing processor adapted to prevent the altering processor from altering the uplink grant if the identified terminal device is different from the terminal device.

In the apparatus, the altering processor may be adapted to alter the uplink grant by modifying a priority of an uplink medium access control flow.

According to a seventh aspect of the invention, there is provided a base station comprising an apparatus according to any of the first to sixth aspects.

According to an eighth aspect of the invention, there is provided an apparatus, comprising monitoring means adapted to monitor if an information is received that an interference at a victim receiving device controlled by the apparatus exceeds a threshold, wherein the interference is caused by a terminal device served by a serving receiving device different from the victim receiving device; instructing means adapted to instruct the serving receiving device to alter an uplink grant of a terminal device served by the serving receiving device based on the received information.

In the apparatus, the instructing means may be adapted to instruct plural receiving devices each being different from the victim receiving device, wherein the plural receiving devices include the serving receiving device.

In the apparatus, the monitoring means may be adapted to monitor if the information comprises an identification of an identified terminal device; wherein the instructing means may be adapted to provide the identification to the serving receiving device

The apparatus may further comprise receiver device identifying means adapted to identify the serving receiving device serving the identified terminal device.

In the apparatus, the monitoring means may be adapted to monitor if the information comprises an identification of the serving receiving device.

The apparatus may further comprise preventing means adapted to prevent the instructing means from instructing any of the plural receiving devices different from the serving receiving device.

In the apparatus, the instructing means may be adapted to instruct the serving receiving device to alter the uplink grant by modifying a priority of at least one of a downlink and an uplink medium access control flow.

According to a ninth aspect of the invention, there is provided an apparatus, comprising monitoring processor adapted to monitor if an information is received that an interference at a victim receiving device controlled by the apparatus exceeds a threshold, wherein the interference is caused by a terminal device served by a serving receiving device different from the victim receiving device; instructing processor adapted to instruct the serving receiving device to alter an uplink grant of a terminal device served by the serving receiving device based on the received information.

In the apparatus, the instructing processor may be adapted to instruct plural receiving devices each being different from the victim receiving device, wherein the plural receiving devices include the serving receiving device.

In the apparatus, the monitoring processor may be adapted to monitor if the information comprises an identification of an identified terminal device; wherein the instructing processor may be adapted to provide the identification to the serving receiving device

The apparatus may further comprise receiver device identifying processor adapted to identify the serving receiving device serving the identified terminal device.

In the apparatus, the monitoring processor may be adapted to monitor if the information comprises an identification of the serving receiving device.

The apparatus may further comprise preventing processor adapted to prevent the instructing processor from instructing any of the plural receiving devices different from the serving receiving device.

In the apparatus, the instructing processor may be adapted to instruct the serving receiving device to alter the uplink grant by modifying a priority of at least one of a downlink and an uplink medium access control flow.

According to a tenth aspect of the invention, there is provided a radio network controller comprising an apparatus according to any of the eighth and ninth aspects.

According to an eleventh aspect of the invention, there is provided a method, comprising monitoring an interference from at least one terminal device not served by an apparatus performing the method; checking if the interference exceeds a threshold; informing, if the interference exceeds the threshold, a serving receiving device considered to serve the at least one terminal device that the interference exceeds the threshold.

In the method the informing may comprise informing plural receiving devices including the serving receiving device by broadcasting or multicasting that the interference exceeds the threshold.

The method may further comprise identifying the serving receiving device serving the at least one terminal device.

The method may further comprise identifying an identified terminal device of the at least one terminal device causing the interference; wherein the identifying of the serving receiving device may comprise identifying the serving receiving device serving the identified terminal device.

In the method, the informing may comprise informing the serving receiving device about at least one of a target interference and an upper limit of the interference, wherein the at least one of the target interference and the upper limit of the interference is related to the threshold.

According to a twelfth aspect of the invention, there is provided a method, comprising monitoring an interference from at least one terminal device not served by an apparatus performing the method; checking if the interference exceeds a threshold; informing, if the interference exceeds the threshold, a control device controlling the apparatus that the interference exceeds the threshold.

The method may further comprise identifying a serving receiving device serving the at least one terminal device; wherein the informing may comprise informing the control device of the serving receiving device.

The method may further comprise identifying an identified terminal device of the at least one terminal device causing the interference; wherein the informing may comprise informing the control device on the identified terminal device.

In the method, the informing may comprise informing the control device about at least one of a target interference and an upper limit of the interference, wherein the at least one of the target interference and the upper limit of the interference is related to the threshold.

According to a thirteenth aspect of the invention, there is provided a method, comprising monitoring if an information is received that an interference at a receiving device not serving a terminal device exceeds a threshold; altering an uplink grant of the terminal device based on the received information, wherein the uplink grant is related to an uplink from the terminal device to an apparatus performing the method.

In the method, the monitoring may comprise monitoring if the information comprises an identification of an identified terminal device; wherein the method may further comprise checking if the identified terminal device is the terminal device; preventing altering the uplink grant if the identified terminal device is different from the terminal device.

In the method, the altering may comprise altering the uplink grant by modifying a priority of an uplink medium access control flow.

According to a fourteenth aspect of the invention, there is provided a method, comprising monitoring if an information is received that an interference at a victim receiving device controlled by an apparatus performing the method exceeds a threshold, wherein the interference is caused by a terminal device served by a serving receiving device different from the victim receiving device; instructing the serving receiving device to alter an uplink grant of a terminal device served by the serving receiving device based on the received information.

In the method, the instructing may comprise instructing plural receiving devices each being different from the victim receiving device, wherein the plural receiving devices include the serving receiving device.

In the method, the monitoring may comprise monitoring if the information comprises an identification of an identified terminal device; wherein the instructing may comprise providing the identification to the serving receiving device

The method may further comprise identifying the serving receiving device serving the identified terminal device.

In the method, the monitoring may comprise monitoring if the information comprises an identification of the serving receiving device.

The method may further comprise preventing instructing any of the plural receiving devices different from the serving receiving device.

In the method, the instructing may comprise instructing the serving receiving device to alter the uplink grant by modifying a priority of at least one of a downlink and an uplink medium access control flow.

Each of the methods of the eleventh to fourteenth aspects may be a method of interference mitigation.

According to a fifteenth aspect of the invention, there is provided a computer program product comprising a set of instructions which, when executed on an apparatus, is configured to cause the apparatus to carry out the method according to any one of the eleventh to fourteenth aspects. The computer program product may be embodied as a computer-readable medium or directly loadable into a computer.

According to some embodiments of the invention, at least one of the following advantages may be achieved (the list of advantages is not comprehensive):
the UL serving grants to interfering UEs are shaped, so as to keep the victim LPN RoT (Rise over Thermal) within acceptable limits;
the uplink capacity of the HetNet deployment is allocated fairly to each receiving node, thus improving system resource utilization;
probability of service degradation to victim users is reduced;
the improvement in uplink capacity may have a positive impact in improving the downlink capacity of the network; this applies in particular to cases where uplink capacity is limiting downlink capacity, e.g. in case of TCP based services (where 10% of return channel capacity is usually required in the uplink to carry the TCP level acknowledgements).
coordination of uplink interference reduces the need of additional network dimensioning and planning when traffic patterns change in a network, e.g. because of different traffic patterns during different times of the day;
interference mitigation prevents wastage of bandwidth by preventing saturation of receiver and triggering of overload control which usually have penalty timers and wherein such decisions typically pessimistically allocate new resources;
New user admission control probability is improved;
Interference mitigation reduces uplink transmit power requirements of UE. This in turn increases overall uplink system capacity and saves UE resources e.g. battery time and life.
the solution is applicable to legacy UEs (fully backward compatible on UE side, i.e. no changes are required from the UE side);
the invention may be implemented according to different levels of complexity. E.g. the solution may be automated using a SON framework which removes the requirement of network dimensioning and planning for a new deployment.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows an exemplary HetNet deployment;

FIG. 2 sketches UL and DL powers in different zones between a macro BTS and a LPN;

FIG. 3 shows a method according to an embodiment of the invention;

FIG. 4 shows a message flow according to an embodiment of the invention;

FIG. 5 shows an apparatus according to an embodiment of the invention;

FIG. 6 shows a method according to an embodiment of the invention;

FIG. 7 shows an apparatus according to an embodiment of the invention;

FIG. 8 shows a method according to an embodiment of the invention;

FIG. 9 shows an apparatus according to an embodiment of the invention;

FIG. 10 shows a method according to an embodiment of the invention;

FIG. 11 shows an apparatus according to an embodiment of the invention; and

FIG. 12 shows a method according to an embodiment of the invention.

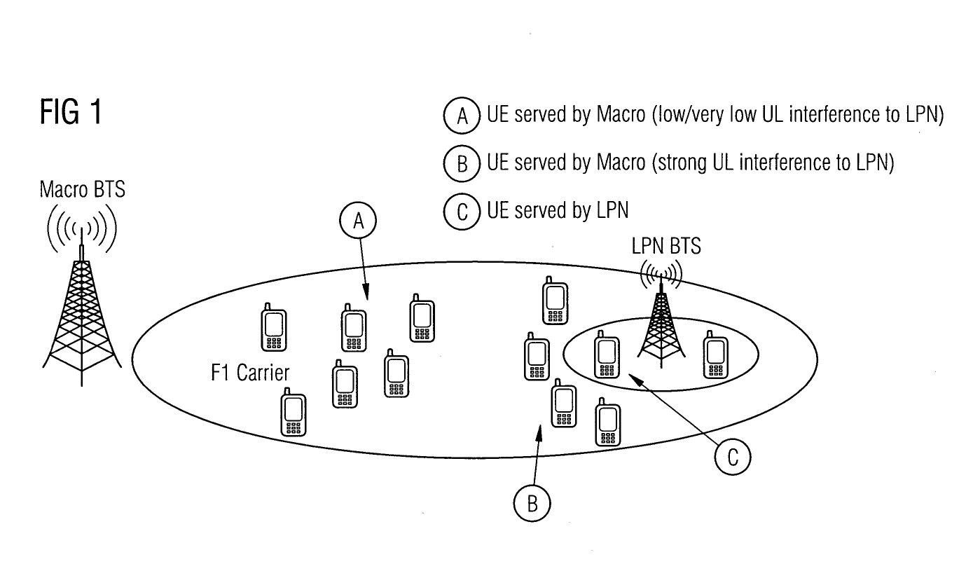

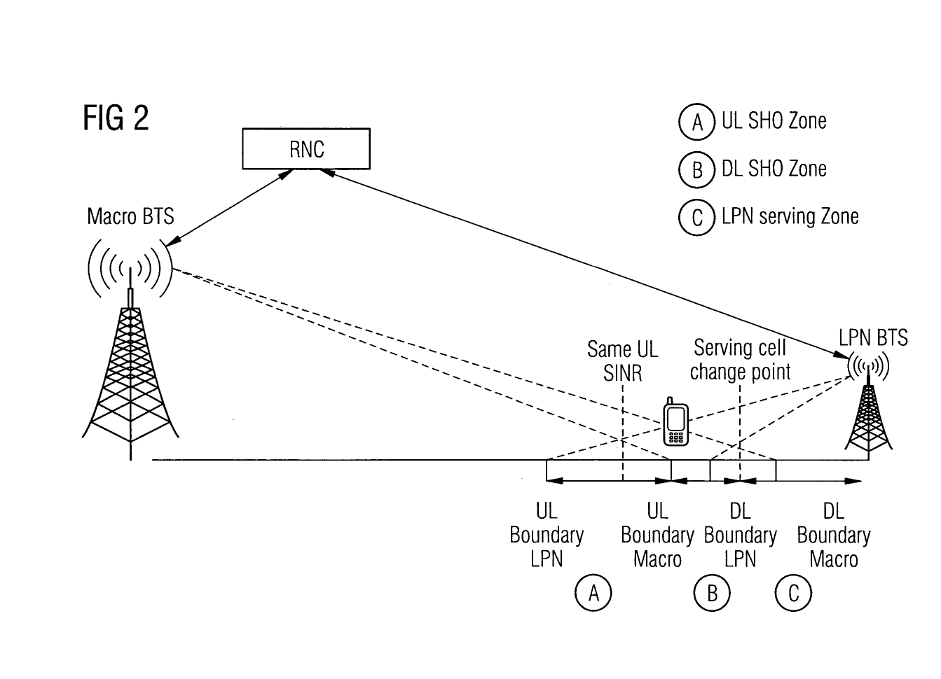

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

According to embodiments of the invention, the victim node provides information to the serving node(s) hosting the interferer(s) so as to help the serving node(s) apply an algorithm to reduce the Serving Grants of the interfering UE(s). The information may be provided on a coarse or a fine level. The information may be provided from the victim node directly to a node (serving node) serving the interferer, via other serving nodes not serving the interferer, and/or via one or more RNCs to the serving node. Simply put, in one embodiment, the victim node would trigger a message to a plurality of serving nodes when the interference received by the victim node crosses a threshold.

### Coarse Control

According to embodiments of the invention employing coarse control, the victim LPN sends a broadcast or multicast message to all the serving nodes (of those interfering UEs) by virtue of which, each of the serving nodes (BTS) re-evaluates the UL Serving Grant.

In some embodiments, the potential serving nodes may be predefined in the victim LPN (e.g. made known by operator configuration). In some embodiments, victim LPN may broadcast or multicast the message to all BTS connected to its RNC, or even to all BTS in the network. In some embodiments, the RNC or potential serving node may forward the message issued by the victim LPN to other potential serving nodes different from the serving node(s) the victim LPN addressed.

In some embodiments, the victim LPN may chose to suppress the message based on dynamic conditions e.g. a specific message from a SON entity asking it to do so or when its uplink users are not numerous enough to be (seriously) affected by the interference.

### Fine Control

According to some embodiments of the invention, when the victim LPN is able to resolve one or a plurality of dominant interferers based on methods mentioned in e.g. Prior art 5, it sends a specific message to the serving BTS (or to the RNC alternatively) to re-evaluate the uplink serving Grant to such interfering UE(s).

Re-evaluation may mean, in the simplest implementation, a direct modification of the UL Serving Grant or it may mean reducing the air interface priority of the UL MAC-d flow (this is another way of limiting the UL throughput). A MAC-d flow is a flow of MAC-d PDUs (in this case originating from the UE) which belong to logical channels which are MAC-d multiplexed. In the context of this paragraph the logical channels are dedicated transport channels originating from the UE.

In some embodiments, the UL serving grant may be reduced by reducing the downlink grant or the DL MAC-d flow.

In some embodiments, reducing of UL serving grant or reducing of the air interface priority of the UL MAC-d flow due to LPN interference may be balanced with other policies of the operator. E.g., for some high priority users (e.g. users with real time traffic), UL serving grant and/or air interface priority of the UL MAC-d flow might not be reduced regardless of whether or not they cause UL interference at LPN.

The message may be routed via the RNC or directly to the potential serving nodes. E.g., the RNC may initiate standardized layer 3 bearer control procedures (e.g. Radio Bearer/Transport Channel/Physical Channel Reconfiguration procedure) to reconfigure UE bearer.

In some embodiments, the RNC participates in the re-evaluation of throughput to this UE by dynamically altering the scheduling priority of the DL MAC-d flow of a particular interfering UE (based on known details about this MAC-d flow, e.g. 3GPP QoS parameters). E.g., as described in WO 2012/143346, the alteration of the scheduling priority of the MAC-d flow is informed to the Node-B/BTS by using the CmCH-PI field in the HS-DSCH Frame Protocol. The RNC may chose to keep the alteration based on RRM. These embodiments thus allow the RNC to reformat the message to the target BTS after performing some internal processing (e.g. provide a joint target to the BTS in case of several individual requests to reduce the Serving Grant).

For example, in some embodiments, a following algorithm is implemented in the RNC to alter the scheduling priority to the serving node(s) based on the following parameters: throughput of UL MAC-d flows for the given UE, SPI of this flow (e.g. penalize flows of lower priority more compared to higher ones). In some embodiments, a fairness algorithm may be used that considers a round robin algorithm to penalize flows. In some embodiments, the bearer of the UE is reconfigured based on this decision.

In some embodiments of the invention, the nodes may use parameters to selectively alter serving grants for interfering UEs. These parameters may be predefined or programmed by the operator of the network. As an example of the usage of such parameters, it is well known that a 2 piecewise linear function with different slopes (the first linear function has a lower slope compared to the latter one which has a sharper slope) could be enabled in the BTS that takes the interference caused by a particular UE and derives the scaling probability of the Serving Grant alteration. In other case the BTS could scale the grant to the UE based on the UE distance to the itself and the victim LPN. There could be many such specific algorithms that could have parameterization, e.g. controlled by the operator.

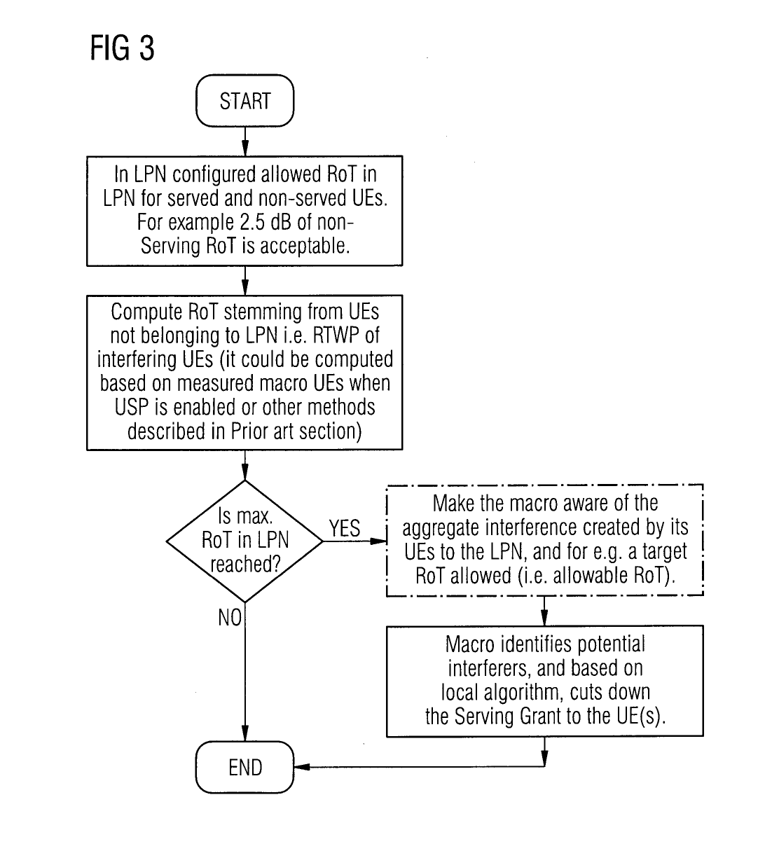

FIG. 3 shows a method according to an embodiment of the invention. The method starts in step S1. According to step S2, it is configured the allowed RoT in the LPN. The value may be defined separately for served and non-served UEs. E.g. for non-served UEs, it may be 2.5 dB.

In step S3, LPN calculates RoT from non-served UEs. This value corresponds to RTWP of the interfering UEs and may be measured if USP is enabled (or by other methods such as those described in the prior art section).

In step S4, it is checked if maximum RoT for the non-served portion of interference is reached. If it is not, the process ends (S5) and may be repeated periodically and/or upon certain events.

If maximum RoT is reached (“yes” in step S4), LPN informs the macro BTS about the exceeding in step S6. E.g., it may provide information on the aggregate interference level, and may also inform about a target RoT. Depending on whether coarse or fine control is implemented, LPN may inform only one or plural BTS.

In step S7, macro identifies potentially interfering UEs and cuts down their serving grant. This may be done based on algorithms performed locally at the macro. E.g., the serving node may identify the UE based on its location in SIZ. E.g., the cutting down may be based on a 2 piecewise linear function with different slopes (the first linear function has a lower slope compared to the latter one which has a sharper slope) that takes the interference caused by a particular UE and derives the scaling probability of the Serving Grant alteration. As another example, the BTS may scale the grant to the UE based on the UE distance to itself and the victim LPN. There may be many such specific algorithms that could have parameterization, e.g. controlled by the operator.

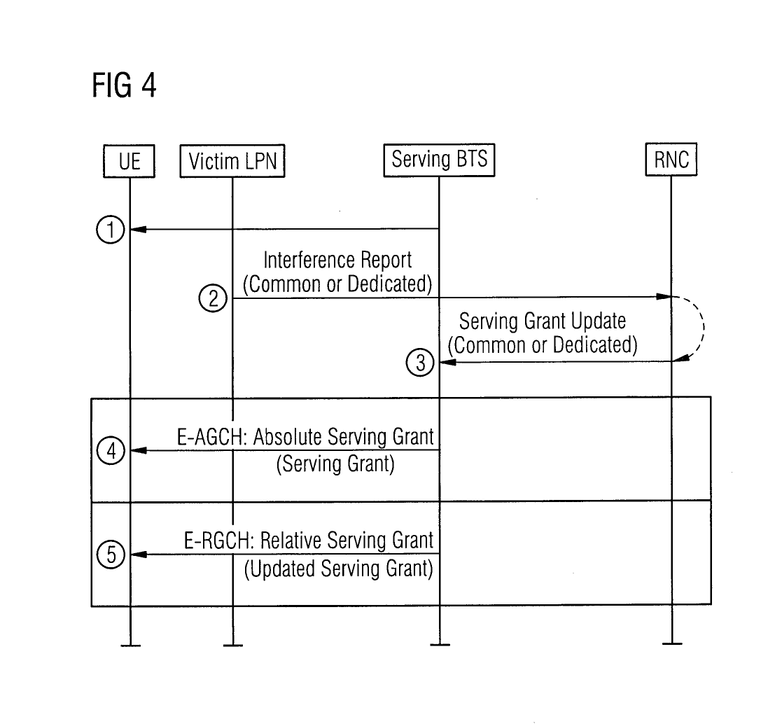

Then, the process ends (S5) and may be repeated periodically and/or upon certain events. FIG. 4 shows a message flow according to an embodiment of the invention. By message 1, the serving BTS gives an uplink grant to the UE. That is, the UE is served by the serving BTS.

The victim LPN may evaluate RoT of non-served UEs (i.e. not served by LPN). If the maximum value of RoT is exceeded, it provides an interference report by message 2. The interference report may comprise an indication that the maximum RoT is exceeded and may in some embodiments additionally comprise information about the RoT and/or the target RoT. The interference report may be provided directly to the serving BTS. It may also be provided (e.g. by broadcasting or multicasting) to other BTS not serving the UE. It may also be provided to the serving BTS (and potentially other BTS) via the RNC (message 3).

Messages 2 and 3 may be a common NBAP or a dedicated NBAP message, depending on whether a group of UEs or a single UE is intended to be controlled.

By either or both of messages 4 and 5 (absolute serving grant and relative serving grant, respectively), the serving BTS alters the uplink grant for the UE. For constructing the respective message, the serving BTS may execute a grant reduction algorithm.

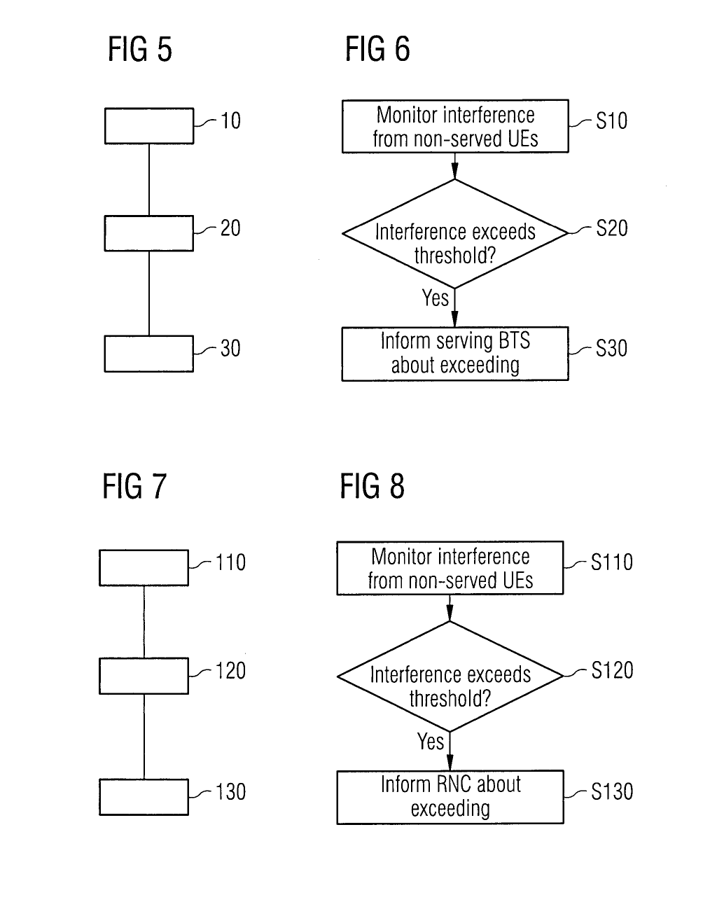

FIG. 5 shows an apparatus according to an embodiment of the invention. The apparatus may be a receiving device such as a NodeB, eNodeB, or BTS, or an element thereof. FIG. 6 shows a method according to an embodiment of the invention. The apparatus according to FIG. 5 may perform the method of FIG. 6 but is not limited to this method. The method of FIG. 6 may be performed by the apparatus of FIG. 5 but is not limited to being performed by this apparatus.

The apparatus comprises monitoring means 10, checking means 20, and informing means 30.

The monitoring means 10 monitors interference from one or more UEs (terminal devices) not served by the apparatus (S10). E.g., it may determine RoT of these UEs.

The checking means 20 checks if the interference monitored by the monitoring means 10 exceeds a threshold (S20). If the threshold is exceeded, the informing means 30 informs a BTS (receiving device) serving one or more of the UEs causing the interference about the exceeding (S30). Additionally, it may inform about the level of interference, a target interference, and/or a maximum acceptable interference, e.g. in terms of respective RoTs.

FIG. 7 shows an apparatus according to an embodiment of the invention. The apparatus may be a receiving device such as a NodeB, eNodeB, or BTS, or an element thereof. FIG. 8 shows a method according to an embodiment of the invention. The apparatus according to FIG. 7 may perform the method of FIG. 8 but is not limited to this method. The method of FIG. 8 may be performed by the apparatus of FIG. 7 but is not limited to being performed by this apparatus.

The apparatus comprises monitoring means 110, checking means 120, and informing means 130.

The monitoring means 110 monitors interference from one or more UEs (terminal devices) not served by the apparatus (S110). E.g., it may determine RoT of these UEs.

The checking means 120 checks if the interference monitored by the monitoring means 110 exceeds a threshold (S120). If the threshold is exceeded, the informing means 130 informs the RNC (control device) controlling the apparatus (e.g. BTS, NodeB, eNodeB) about the exceeding (S130). Additionally, it may inform about the level of interference, a target interference, and/or a maximum acceptable interference, e.g. in terms of respective RoTs.

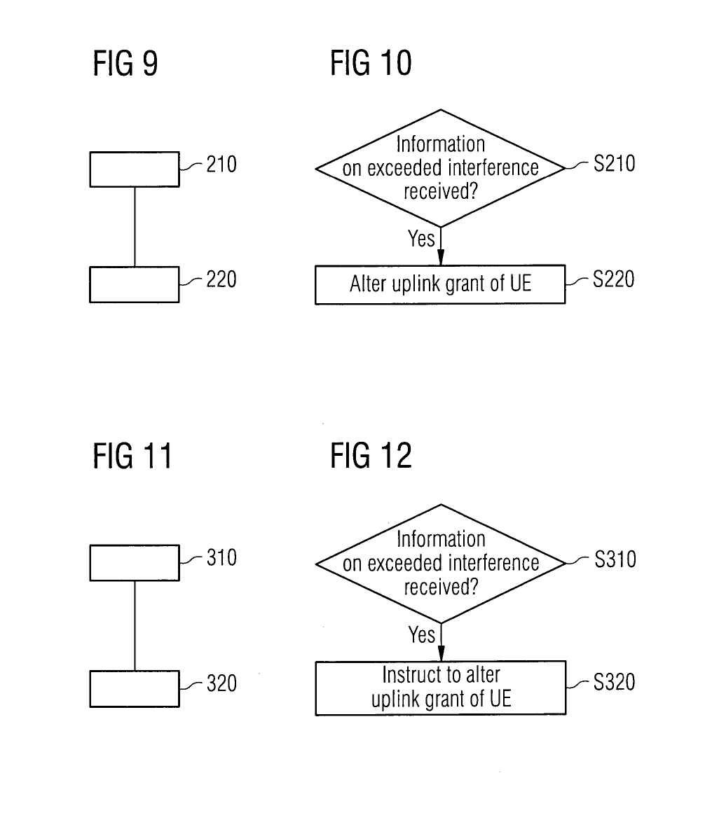

FIG. 9 shows an apparatus according to an embodiment of the invention. The apparatus may be a receiving device such as a NodeB, eNodeB, or BTS, or an element thereof. FIG. 10 shows a method according to an embodiment of the invention. The apparatus according to FIG. 9 may perform the method of FIG. 10 but is not limited to this method. The method of FIG. 10 may be performed by the apparatus of FIG. 9 but is not limited to being performed by this apparatus.

The apparatus comprises monitoring means 210 and altering means 220.

The monitoring means 210 monitors if an information is received that, at a receiving device (such as a BTS, NodeB, eNodeB), an interference exceeds a threshold (S210). The interference may be caused by a terminal device (UE). Based on this information, the altering means 220 alters an uplink grant of the terminal device to the apparatus (S220).

FIG. 11 shows an apparatus according to an embodiment of the invention. The apparatus may be a control device such as a RNC, or an element thereof. FIG. 12 shows a method according to an embodiment of the invention. The apparatus according to FIG. 11 may perform the method of FIG. 12 but is not limited to this method. The method of FIG. 12 may be performed by the apparatus of FIG. 11 but is not limited to being performed by this apparatus.

The apparatus comprises monitoring means 310 and instructing means 320.

The monitoring means 310 monitors if an information is received that, at a receiving device (such as a BTS, NodeB, eNodeB), an interference exceeds a threshold (S310). The interference may be caused by a terminal device (UE) not served by the receiving device. Based on this information, the instructing means 320 instructs another receiving device (such as a

BTS, NodeB, eNodeB) serving the terminal device to alter an uplink grant of the terminal device to the serving receiving device (S320).

### Comparison to Prior Art

### Prior art 1 (PCT/EP2013/057220):

In embodiments of the present invention, it is assumed that the LPN is not in the UE active set, although the interfering UEs UL transmission should be restricted by applying a reduction in the Macro Serving Grant. Thus, the technical problem solved by embodiments of the present invention is completely different from that of prior art 1 (interference mitigation v/s enhanced scheduling).

Enhanced scheduling may also imply assigning a better Serving Grant. However, embodiments of the present invention are directed to reduction in the serving grant. That is, a manipulation of the serving grant to the UE is intended by prior art 1 and by embodiments of the present invention. However, the problem space served by both the described solutions is complementary.

### Prior Art 2 (3GPP R1-131575):

Prior art 2 requires modifications on the UE interface. Hence, this solution is useful only for Rel12+UEs. On the other hand, embodiments of the present invention apply to all kinds of UEs since the UE interface is not modified.

### Prior Art 3 (ICIC):

Prior art 3, proposes a completely different solution in controlling interference in the same problem context as the present invention.

### Prior Art 4 (PCT/EP2013/057190):

Embodiments of the invention may rely on prior art 4 as one of the possible solutions to detect the presence of interfering UEs in Strong Imbalance Zone.

In some embodiments, the roles of macro BTS and LPN may be interchanged. That is, UEs served by LPN may interfere to the UL to the macro BTS. E.g., this may happen for high power LPNs of e.g. 37 dBm.

Instead of in LTE or LTE-A, embodiments of the invention may be employed in other radio networks where link imbalance may occur, such as CDMA, EDGE, UMTS, WiFi networks, etc. A terminal (device) or a user equipment may be a mobile phone, a smart phone, a PDA, a laptop or any other terminal which may be attached to networks of the respective technologies such as LTE, LTE-A or UMTS. A transmitting device (transmitter) may be any base station (BTS) of the respective technology such as a NodeB, an eNodeB, an access point, etc., irrespective of its coverage area, such as macro cell, pico cell, femto cell. In particular, in the present application, NodeB and eNodeB are considered to be equivalent to each other if not otherwise stated or clear from the context.

Embodiments of the invention are explained with special emphasis on LPNs. However, the embodiments may be applied not only to LPNs but to any type of cells including macro cells.

The provided/received information may comprise one or more pieces of information related to different meanings. It is independent from the realization. Hence, it may comprise a single value (which may have several meanings, e.g. each bit or byte of the value may be related to a different meaning), plural fields of an array, plural information elements, etc. One information may be transmitted in one or plural messages.

Names of network elements, protocols, and methods are based on current standards. In other versions or other technologies, the names of these network elements and/or protocols and/or methods may be different, as long as they provide a corresponding functionality.

In the context of the present application, “serving” includes at least “providing an uplink grant”.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a base station device such as an eNB, or a component thereof, an apparatus embodying the same, a method for controlling and/or operating the same, and computer program(s) controlling and/or operating the same as well as mediums carrying such computer program(s) and forming computer program product(s). Furthermore, it should thus be apparent that exemplary embodiments of the present invention provide, for example a radio network controller such as an RNC, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. Apparatus, comprising
monitoring means adapted to monitor an interference from at least one terminal de-vice not served by the apparatus;
checking means adapted to check if the interference exceeds a threshold;
informing means adapted to inform, if the interference exceeds the threshold, a serving receiving device considered to serve the at least one terminal device that the interference exceeds the threshold.

2. The apparatus according to claim 1, wherein
the informing means is adapted to inform plural receiving devices including the serving receiving device by broadcasting or multicasting that the interference exceeds the threshold.

3. The apparatus according to claim 1, further comprising
receiver identifying means adapted to identify the serving receiving device serving the at least one terminal device.

4. The apparatus according to claim 3, further comprising
terminal identifying means adapted to identify an identified terminal device of the at least one terminal device causing the interference; wherein
the receiver identifying means is adapted to identify the serving receiving device serving the identified terminal device.

5. The apparatus according to claim 1, wherein
the informing means is further adapted to inform the serving receiving device about at least one of a target interference and an upper limit of the interference, wherein the at least one of the target interference and the upper limit of the interference is related to the threshold.

6. Apparatus, comprising
monitoring means adapted to monitor an interference from at least one terminal device not served by the apparatus;
checking means adapted to check if the interference exceeds a threshold;
informing means adapted to inform, if the interference exceeds the threshold, a control device controlling the apparatus that the interference exceeds the threshold.

7. The apparatus according to claim 6, further comprising
receiver identifying means adapted to identify a serving receiving device serving the at least one terminal device; wherein
the informing means is further adapted to inform the control device of the serving receiving device.

8. The apparatus according to claim 6, further comprising
terminal identifying means adapted to identify an identified terminal device of the at least one terminal device causing the interference; wherein
the informing means is further adapted to inform the control device on the identified terminal device.

9. The apparatus according to claim 6, wherein
the informing means is further adapted to inform the control device about at least one of a target interference and an upper limit of the interference, wherein the at least one of the target interference and the upper limit of the interference is related to the threshold.

10. Apparatus, comprising
monitoring means adapted to monitor if an information is received that an interference at a receiving device not serving a terminal device exceeds a threshold;
altering means adapted to alter an uplink grant of the terminal device based on the received information, wherein the uplink grant is related to an uplink from the terminal device to the apparatus.

11. The apparatus according to claim 10, wherein
the monitoring means is further adapted to monitor if the information comprises an identification of an identified terminal device; wherein the apparatus further comprises
checking means adapted to check if the identified terminal device is the terminal device;
preventing means adapted to prevent the altering means from altering the uplink grant if the identified terminal device is different from the terminal device.

12. The apparatus according to claim 10, wherein
the altering means is adapted to alter the uplink grant by modifying a priority of an uplink medium access control flow.

13. (canceled)

14. Apparatus, comprising
monitoring means adapted to monitor if an information is received that an interference at a victim receiving device controlled by the apparatus exceeds a threshold, wherein the interference is caused by a terminal device served by a serving receiving device different from the victim receiving device;
instructing means adapted to instruct the serving receiving device to alter an uplink grant of a terminal device served by the serving receiving device based on the received information.

15. The apparatus according to claim 14, wherein
the instructing means is adapted to instruct plural receiving devices each being different from the victim receiving device, wherein the plural receiving devices include the serving receiving device.

16. The apparatus according to claim 14, wherein
the monitoring means is adapted to monitor if the information comprises an identification of an identified terminal device; wherein
the instructing means is adapted to provide the identification to the serving receiving device.

17. The apparatus according to claim 16, further comprising
receiver device identifying means adapted to identify the serving receiving device serving the identified terminal device.

18. The apparatus according to claim 14, wherein
the monitoring means is adapted to monitor if the information comprises an identification of the serving receiving device.

19. (canceled)

20. (canceled)

21. (canceled)

22. Method, comprising
monitoring an interference from at least one terminal device not served by an apparatus performing the method;
checking if the interference exceeds a threshold;
informing, if the interference exceeds the threshold, a serving receiving device Considered to serve the at least one terminal device that the interference exceeds the threshold.

23. (canceled)

24. (canceled)

25. (canceled)

26. A computer program product comprising a set of instructions which, when executed on an apparatus, is configured to cause the apparatus to carry out the method according to claim 22.

27. The computer program product according to claim 26, embodied as a computer-readable medium or directly loadable into a computer.
